(19) United States
(12) Patent Application Publication
(10) Pub. No.: US 2021/0146456 A1
(43) Pub. Date: May 20, 2021

(54) METHOD AND DEVICE FOR MACHINING A COMPONENT BY REMOVING MATERIAL

(71) Applicant: SIEMENS AKTIENGESELLSCHAFT, MÜNCHEN (DE)

(72) Inventors: Michael Clossen-von Lanken Schulz, Issum (DE); Stefan Obermayr, Duisburg (DE)

(21) Appl. No.: 16/627,475

(22) PCT Filed: Jun. 6, 2018
(86) PCT No.: PCT/EP2018/064853

§ 371 Date: Dec. 30, 2019

(30) Foreign Application Priority Data
Jul. 12, 2017 (DE) 10 2017 211 904.7

(51) Int. Cl. B23C 3/30

(52) U.S. Cl. CPC B23C 3/30

(57) ABSTRACT

Provided is a method for machining a component by removing material, in particular by removing chips, within a groove provided in the component, in which method: spatially resolved measurement data, which include information about faults, in particular cracks in the component, are provided, and machining of the component by removing material, in particular by removing chips, is performed by means of at least one machining tool mounted for movement in a motorized manner, in particular for translation and/or pivoting in a motorized manner, and is controlled in accordance with the provided measurement data preferably in an automated manner with respect to the positions on the component at which the at least one machining tool is brought into engagement with the component in order to remove material in the region of faults that are present.

### CROSS-REFERENCE TO RELATED APPLICATIONS

This application claims priority to PCT Application No. PCT/EP2018/064853, having a filing date of Jun. 6, 2018, which is based on German Application No. 10 2017 211 904.7, having a filing date of Jul. 12, 2017, the entire contents both of which are hereby incorporated by reference.

### FIELD OF TECHNOLOGY

The following relates to a method for carrying out material-removing, in particular cutting, machining of a component, in particular within a slot provided in the component, and a device for this.

### BACKGROUND

In the field of turbines, especially, components are subject to high mechanical, chemical and thermal loads, which can be linked to wear and destruction. For example, in the region of the blade-root receiving slots, which are formed on the rotor and in which the rotor blades of the turbine are held, crack formations occur as a result of the stress, which can significantly reduce the useful life of the turbine rotor.

If, in the region of the blade-root receiving slots on a rotor, cracks or other flaws are present which can be discovered via methods for non-destructive testing of components, for instance via eddy-current crack testing or magnetic-particle crack testing, these have to be removed. In particular, according to conventional art, cutting machining tools are used for this purpose.

DE 10 2015 222 529 A1 reveals a milling device, which comprises an elongated base body, which is adapted, in terms of its cross-section, to the cross-section of a blade-root receiving slot to be machined and on which a milling tool is held. For machining, the base body, adapted in terms of its form, can be introduced into a blade-root receiving slot and moved through this with negligible play. The milling tool, which is, in particular, a milling finger, is held on the base body to be rotatable about a tool axis of rotation. Specifically, the tool is arranged in a recess, which is provided in the lower region of the base body and is formed by a continuous slot oriented perpendicularly to the longitudinal extent thereof. The tool is held within the receiving means to be pivotable about a pivot axis, extending perpendicularly to the tool axis of rotation, in such a way that the tool can be moved between a position in which it is received completely in the recess and a position in which its tip and a predetermined amount protrudes outwards from the base body. For cutting machining of the rotor in the region of a blade-root receiving slot, the base body is inserted into the slot and pushed slightly therein. The milling tool is pivoted through its pivot axis in such a way that it protrudes outwards from the recess, wherein the desired protrusion amount, which corresponds to the penetration depth of the tool into the component to be machined and therefore the quantity of material to be removed, is set manually. The milling tool is then rotated at its tool axis of rotation and a feed movement of the tool is realized in that the base body is moved manually by a user through the blade-root receiving slot to be machined. This results in the generation of a milled slot along the blade-root receiving slot, with a constant cross-section over its longitudinal extent.

The known milling device has, in principle, been proven to remove flaws, in particular cracks, in components, especially rotors, in the region of the blade-root receiving slots. However, with this, a comparatively high amount of material is removed in each case over the entire longitudinal extent of a blade-root receiving slot. Depending on the component geometry, little material is available in any case, at least in some portions, which means that comparatively extensive material removal can prove to be less advantageous.

### SUMMARY

An aspect relates to a method and a device for material-removing, in particular cutting, machining of a component, which is notable for reliably removing flaws in a component whilst removing less material than in conventional art. At the same time, by means of the device and the method, it should be possible, in particular, to produce machining contours which are calculated and can, in turn, be inspected using a method for non-destructive testing.

This aspect is achieved by a method for carrying out material-removing, in particular cutting, machining of a component, in particular within a slot provided in the component, in which locally resolved measurement data, which comprise information relating to flaws, in particular cracks, in the component, are provided, and material-removing, in particular cutting, machining of the component takes place by means of at least one machining tool, mounted to be movable in a motorized manner, in particular displaceable and/or pivotable in a motorized manner, and the positions on the component at which the at least one machining tool is brought into engagement with the component in order to remove material in the region where flaws are present is controlled in a preferably automated manner depending on the measurement data provided, and, in particular, the depth to which the at least one machining tool is driven into the component is controlled in a preferably automated manner depending on the measurement data provided.

In other words, the basic idea of embodiments of the present invention consists in using acquired location-dependent measurement data relating to flaws, for instance cracks, present in a component for targeted flaw-removing machining which enables the amount of material removed to be minimized. According to embodiments of the invention, the control of at least one material-removing tool takes place depending on the flaw-related findings to remove flaws which are found to be present. Specifically, according to embodiments of the invention, the positions on a component to be machined at which at least one machining tool is brought into engagement in order to remove material, and, in particular, the depth to which the machining tool is driven into the component, are controlled in a preferably automated manner depending on the locally resolved measurement data relating to component flaws.

To this end, the measurement data can be read into a control device connected to the at least one machining tool and the control device controls the at least one machining tool depending on the measurement data. In this case, the alignment of the at least one tool whilst it is moved along the component to be machined may be varied by the control device, depending on where flaws are specifically present.

If, for example, machining takes place in order to remove flaws, in particular cracks, in the region of a slot, in particular a blade-root receiving slot, according to embodiments of the invention, the machining depth is varied in particular in the longitudinal direction of the slot, i.e. in the axial direction in the case of a turbine blade, on the basis of provided measurement data relating to flaws which are present, for example on the basis of eddy current data, namely depending on flaws which are specifically present.

Since, according to embodiments of the invention, a machining tool held in a motorized manner is used, the position of which is altered in a motorized manner and not manually—for varying the machining depth according to the actual flaw-related findings, a calculable machining contour is obtained. A machining contour which is calculated using the finite element method, for example, can be used for analysis of the useful life.

In one embodiment of the method, it is provided that a base body on which the at least one machining tool is held to be movable in a motorized manner, in particular displaceable and/or pivotable in a motorized manner, is displaced manually along the component and the positions on the component at which the at least one machining tool is moved relative to the base body in such a way that it comes into engagement with the component in order to remove material, and, in particular, the depth to which it is driven in, are controlled in an automated manner depending on the measurement data provided.

It can furthermore be provided that material-removing machining takes place within a slot, in particular within a blade-root receiving slot of a turbo-machine, and measurement data are preferably provided, which, at least with regard to the direction of the longitudinal extent of the slot, comprise locally resolved information relating to flaws, in particular cracks, in the component in the region of the slot, and the base body is displaced in the direction of the longitudinal extent of the slot.

If machining takes place in the region of a slot, in particular a blade-root receiving slot, the base body used is preferably notable for a cross-section which is adapted to the cross-section of the slot, in particular the blade-root receiving slot, as is also revealed in DE 10 2015 222 529 A1.

In this case, it can be provided, in particular, that the at least one machining tool is held on the base body to be pivotable about at least one pivot axis and the positions on the component at which the at least one machining tool is pivoted and the amount by which the at least one machining tool is pivoted and, in particular, the angle through which the at least one machining tool is pivoted are controlled in particular depending on the measurement data provided.

It can alternatively or additionally be provided that the at least one machining tool is held on the base body to be displaceable along at least one, in particular linear, displacement path and the positions on the component at which the at least one machining tool is displaced along the displacement path and the amount by which the at least one machining tool is displaced along the displacement path are controlled in particular depending on the measurement data provided. The at least one tool is, in particular, vertically adjustably held on the base body.

With regard to the generation of the measurement data which are provided according to embodiments of the invention for the preferably automated control of the machining tool, it can be provided that they are acquired by means of one or more probes which are held on the base body together with the at least one machining tool. Accordingly, a further embodiment of the method is notable in that a base body, on which at least one test probe for non-destructive testing of the component is held, is displaced along the component and, using the at least one test probe held on the base body, measurement data are acquired, which comprise locally resolved information relating to flaws, in particular cracks, in the component, and the acquired measurement data are provided for controlling the at least one machining tool held on the base body.

In this case, whilst the base body is displaced along the component to be machined, both the acquisition of the measurement data as well as the material removal take place in practically one step.

The test probe or test probes is/are preferably arranged on the base body in such a way that, upon displacement of the base body in a predetermined displacement direction, non-destructive testing of the component firstly takes place by means of the at least one test probe, followed by mechanical machining by means of the at least one machining tool. Of course, it is also possible that the base body provided with test probe(s) or tool(s) is displaced twice along a component, in particular pushed twice through a slot; once for generating the measurement data relating to flaws which are present and once for the mechanical machining for removing flaws. This is advantageous in that the acquisition of measurement data is not disrupted by vibrations or the like which may occur during the mechanical processing.

Alternatively to using a base body equipped for both testing and machining, it can also be provided that two base bodies, preferably having at least substantially the same form, are displaced in succession along the component, wherein at least one test probe for non-destructive testing of the component is held on the first base body displaced first along the component, and, using the at least one test probe held on the first base body, measurement data are acquired, which comprise locally resolved information relating to flaws, in particular cracks, in the component, and wherein the at least one machining tool is held to be movable in a motorized manner on the second base body which is subsequently displaced along the component, and the measurement data acquired using the at least one test probe held on the first base body are provided for controlling the at least one machining tool held on the second base body.

A further embodiment is notable in that the measurement data provided in relation to the depth of flaws, in particular cracks, present in the component to be machined comprise depth values and local coordinates which are associated with the depth values in each case and indicate the respective flaw position. The depth values can be, in particular, amplitude values, which is the case, for example, when the measurement data have been obtained by non-destructive, eddy current-based testing of the component. If the measurement data comprise depth values, it is preferably provided that the at least one machining tool is brought into engagement with the component at positions in which, according to the measurement data, there is a depth value higher than a predetermined limit value. It can then alternatively or additionally be provided that the at least one machining tool is driven into the component in each case by a depth which is dependent on the amount of the depth value.

A further advantageous embodiment is notable in that, on the basis of the measurement data provided, at least one envelope is calculated, which includes a plurality, preferably all, of the flaws present according to the measurement data, in particular with the respectively corresponding flaw depth. The at least one machining tool is then preferably controlled in such a way that material removal corresponding to the at least one envelope is achieved. This procedure enables the removal of material to be optimally adapted to actual flaw-related findings and a contour which is, itself, again easily testable to be obtained. A plurality of envelopes, in particular pertaining to different slot depths, can be calculated and material removal corresponding thereto can be achieved.

The position determination takes place particularly preferably using at least one position encoder device, which is/are held in particular on the base body. In this case, one or more position encoder device(s) are used both for determining the local coordinates of a flaw present in a component and for determining the position of the at least one machining tool relative to the component. These each preferably have a position detection body movably, in particular rotatably, mounted on the base body, and in particular the further base body, for instance in the form of a roller which moves with the base body or further base body as this is displaced along the component, whereby the displacement path can be detected.

The above aspect is furthermore achieved by a device for material-removing, in particular cutting, machining of a component, in particular within a slot provided in the component, comprising
a preferably elongated base body, which is to be displaced along a component for machining thereof,
at least one material-removing, in particular cutting, machining tool, which is held on the base body to be movable in a motorized manner, in particular displaceable and/or pivotable in a motorized manner,
at least one position encoder device, held on the base body, for determining local coordinates, and
a control device, which is connected, or can be connected, to the at least one machining tool and in particular the at least one position encoder device, preferably via cables, and is designed and equipped to receive locally resolved measurement data, which comprise information relating to flaws, in particular cracks, in a component to be machined, and to control the at least one machining tool depending on the measurement data.

A device which is configured in this way is particularly suitable for carrying out the method according to embodiments of the invention.

In a preferred embodiment, the control device comprises at least one, in particular programmable, microcontroller or is formed by such. If at least one microcontroller is provided, this preferably has a circuit board and/or a microprocessor and/or a plurality of input/output connections. The microcontroller is especially preferably formed as an Arduino board, or comprises such. Programmable microcontrollers marketed under the trade name Arduino are already known from conventional art. These comprise, in particular, a printed circuit board with a microprocessor and input/output pins. The control device can be arranged within the preferably hollow-formed base body. Alternatively, the control can via a computer

In a preferred embodiment of the device, at least one test probe for non-destructive testing of a component is provided, which is arranged on the base body or on a further base body, preferably having at least substantially the same form as the base body, on which at least one further position encoder device for determining local coordinates is held. The control device is then preferably connected to the at least one test probe and equipped to control the at least one machining tool depending on measurement data acquired by the at least one test probe. A plurality of test probes forming a test probe array is particularly preferably held on the base body or the further base body.

In a further development of the device according to embodiments of the invention, it is provided that at least two position encoder devices for determining local coordinates are held on the base body, and the position encoder devices preferably each have a position detection body, which is movably, in particularly rotatably, held on the base body and is arranged in such a way that it can be brought into contact with the surface of a component to be inspected, wherein each position encoder device held on the base body is designed, in reaction to its position detection body being moved relative to the base body, to output a movement signal which contains information relating to the current speed of the movement of the position detection body relative to the base body or from which such information can be derived, and a position encoder evaluation unit, arranged in particular in the base body, is preferably provided, which is connected to the position encoder devices held on the base body and is designed and equipped to receive movement signals from the position encoder devices during operation and to establish, continuously or at predetermined time intervals, which position encoder device held on the base body has the fastest-moving position detection body, and in particular to output the movement signal of the position encoder device having the fastest-moving position detection body.

If the device comprises two base bodies, wherein the at least one test probe is held on the one base body and the at least one machining tool is held on the other base body, analogously to this, the further, second base body can be notable for at least two position encoder devices. Accordingly, in a further embodiment, it is provided that at least two position encoder devices for determining local coordinates are held on the further base body, and the position encoder devices preferably each have a position detection body, which is movably, in particular rotatably, held on the further base body and is arranged in such a way that it can be brought into contact with the surface of a component to be inspected, wherein each position encoder device held on the further base body is designed, in reaction to its position detection body being moved relative to the further base body, to output a movement signal which contains information relating to the current speed of the movement of the position detection body relative to the further base body or from which such information can be derived, and a position encoder evaluation unit, arranged in particular in the further base body, is preferably provided, which is connected to the position encoder devices held on the base body and is designed and equipped to receive movement signals from the position encoder devices during operation and to establish, continuously or at predetermined time intervals, which position encoder device held on the further base body has the fastest-moving position detection body, and in particular to output the movement signal of the position encoder device having the fastest-moving position detection body.

In a particularly preferred configuration, the position encoder evaluation unit comprises at least one, in particular programmable, microcontroller or is formed by such. If at least one microcontroller is provided, this preferably has a circuit board and/or a microprocessor and/or a plurality of input/output connections. For example, the microcontroller is formed as an Arduino board or comprises such.

It can alternatively or additionally be provided that the position encoder evaluation unit is arranged within the preferably hollow-formed base body or within the preferably hollow-formed further base body.

The base body preferably has a substantially constant cross-section along its longitudinal extent. The base body is alternatively or additionally notable for a fir-tree- or swallow- or tee- or hammer-head-shaped cross-section. If the device comprises a base body and a further base body for separate generation of the measurement data and mechanical machining, the further base body can likewise be notable for the above-mentioned features, in each case in isolation or in combination.

It can furthermore be provided that the at least one machining tool is held on the base body to be pivotable about a pivot axis and/or displaceable along a preferably linear displacement path and, in particular, the control device is designed and equipped to pivot the at least one machining tool about the pivot axis and/or displace it along the displacement path depending on the measurement data provided.

The control device is particularly preferably designed and equipped to carry out the method according to embodiments of the invention.

The machining contours resulting from the post-machining according to embodiments of the invention are notable since, according to the embodiments of the invention, material is only ever removed at those axial positions at which flaws are actually present due to a non-constant cross-section in the axial direction. To enable reliable non-destructive re-testing of machining contours produced in the manner according to embodiments of the invention, it can furthermore be provided that the test probe or test probes are held in a resilient manner on the base body or further base body in such a way that they protrude outwards from the base body and are movable into the base body in the direction thereof in opposition to a spring force. As a result of the resilient mounting, it is also ensured that, when testing machining contours with a varying cross-section, the test probes are always in contact with the surface of the machining contour whilst the base body is displaced along the component to be machined, in particular moved through a (blade-root receiving) slot. If resiliently mounted probes are used to inspect a component which has already been machined according to embodiments of the invention, the contour thereof is preferably adapted to the contour of the milling tool used for the previous machining. The test probes can then nestle in the milled slot according to the milling depth and are minimally spaced, in the optimum case not spaced, from the surface to be measured.

For re-testing an already-machined component, a base body is preferably used, which has test probes specifically at those points which are known to be subject to particular stress. Therefore, remaining flaws, in particular cracks, can also be detected particularly well.

If resiliently mounted test probes are used for testing already-machined components, a base body is particularly preferably used on which test probes are provided at those points at which, according to previous testing

### BRIEF DESCRIPTION

Some of the embodiments will be described in detail, with reference to the following figures, wherein like designations denote like members, wherein:

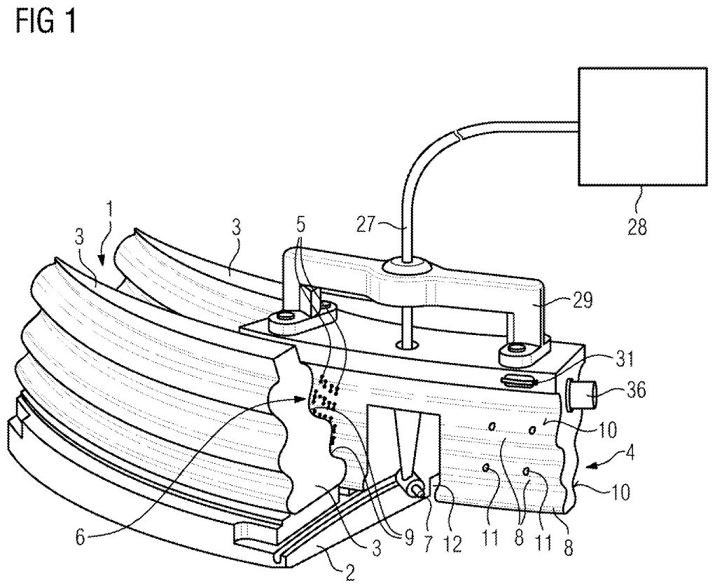

FIG. 1 is a schematic illustration of a device for milling according to an embodiment of the present invention, whereof the base body is inserted into a slot of a component to be machined;

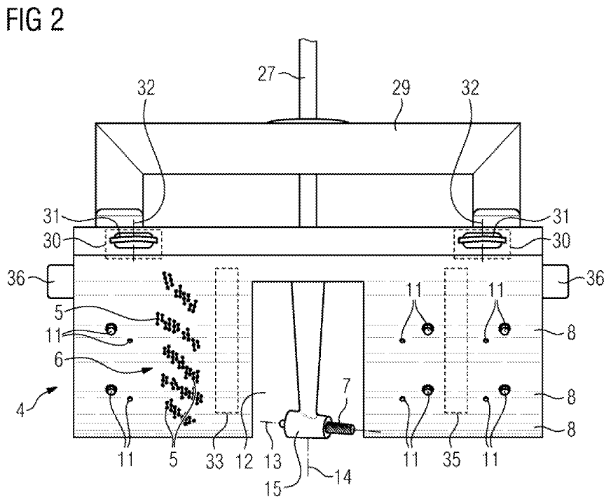

FIG. 2 is a side view of the device illustrated in FIG. 1;

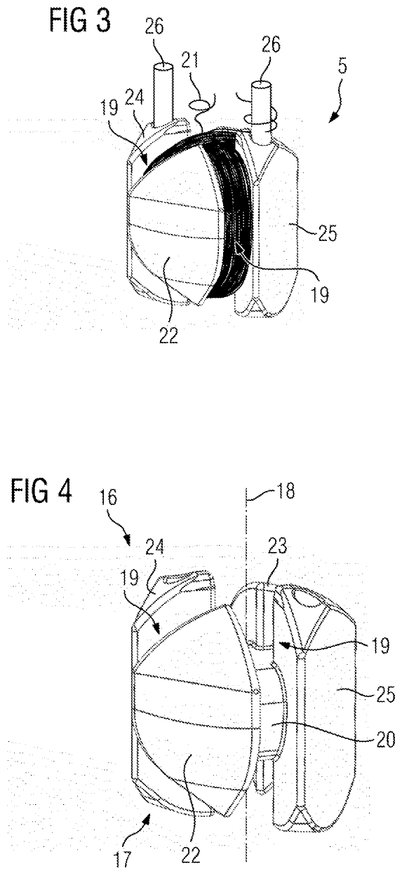

FIG. 3 is an eddy current test probe, held on the base body of FIG. 1, illustrated schematically on an enlarged scale;

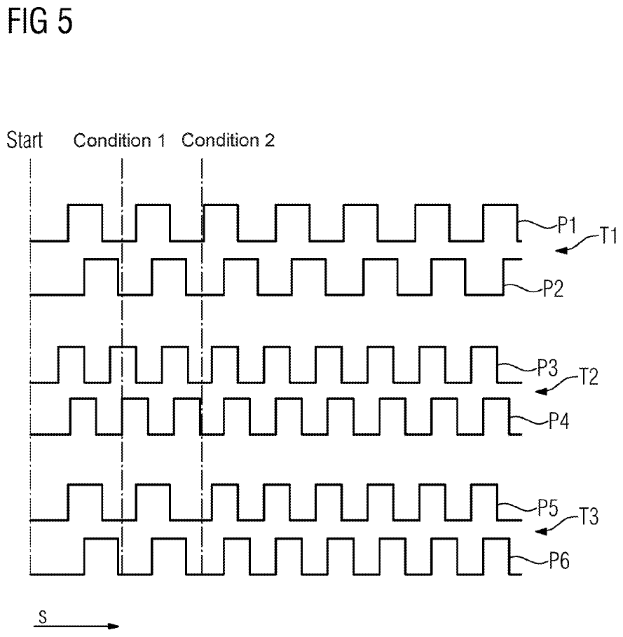

FIG. 4 is the coil former of the eddy current test probe of FIG. 3, in a perspective front view;

FIG. 5 is a chart showing the TTL signals of the position encoder devices of the device of FIG. 1 and the TTL signal output by the position encoder evaluation unit of the device;

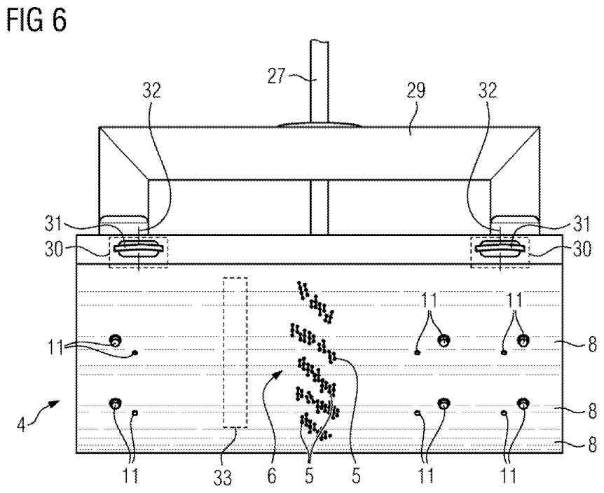

FIG. 6 is a first base body, equipped with an eddy current test probe array, of a second embodiment of a device according to the invention in a schematic illustration;

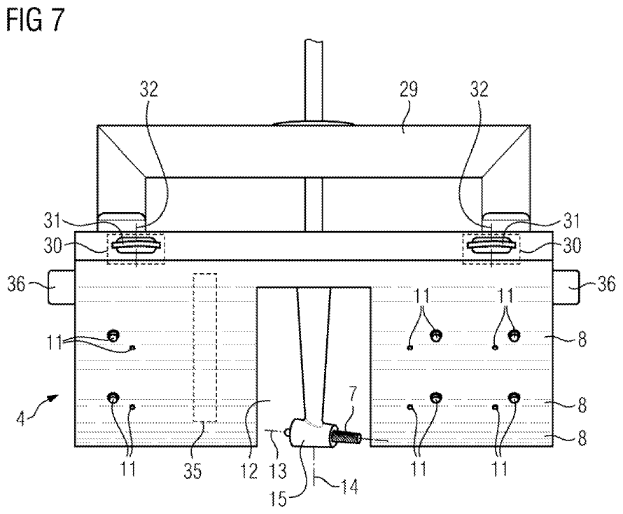

FIG. 7 is a second base body, equipped with a milling tool, of the second embodiment of the device according to the invention in a schematic side view; and

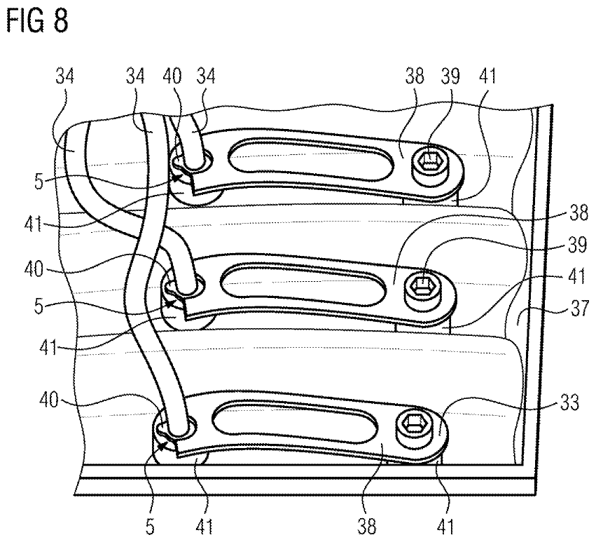

FIG. 8 is a schematic sectional view of the inner wall of an open base body with resiliently held test probes.

### DETAILED DESCRIPTION

FIG. 1 shows, in a schematic perspective view, a first embodiment of a device according to embodiments of the invention, which is designed to carry out milling within a blade-root receiving slot 1 of a rotor 2 (only partially illustrated in FIG. 1) of a turbo-machine, in which a side wall of a rotor claw 3 defining the blade receiving slot 1 is machined by cutting. The blade-root receiving slots 1 of the rotor 2 are constructed identically and, in the present case, have a constant fir-tree-shaped cross-section along their longitudinal extent.

The illustrated exemplary embodiment of the device according to embodiments of the invention comprises, as main components, a hollow base body 4 of plastics material, on which a plurality of eddy current test probes 5, which form a test probe array 6, is held, and a milling tool 7, which is likewise held on the base body 4 and, in the present case, is formed by a milling finger.

A side view of the base body 4 with the test probe array 6 and milling tool 7 can be seen in FIG. 2.

The base body 4 is elongated in form and has, along its longitudinal extent, a substantially constant cross-section which is adapted to the fir-tree-shaped cross-section of the blade-root receiving slots 1. Accordingly, this can be introduced into a blade-root receiving slot 1 and moved through this with negligible play, wherein projections 8 of the base body 4, which extend along the longitudinal extent of the base body 4 and protrude perpendicularly to the longitudinal extent, reach into associated depressions 9 of the receiving slots 1 (c.f. in particular FIG. 1).

To compensate the play present between the mutually opposing rotor claws 3 and the base body 4, spring pressure pieces 11 are arranged distributed over the side walls 10 of the base body 4, the hemispherically formed free ends of which protrude outwards from the base body 4 and are movable in the direction of the base body 4 in opposition to a spring force.

In the lower region of the base body 4, a recess 12, in the form of a continuous slot, is provided in the longitudinal extent. Within this, the milling tool 7, which is rotatable about a tool axis of rotation 13, is held to be pivotable about a pivot axis 14, extending perpendicularly to the tool axis of rotation 13, in such a way that the milling tool 7 can be moved between a position in which it is received completely in the recess 12 and a position in which its tip protrudes outwards from the base body 4 by a predetermined amount, as illustrated, for example, in FIG. 1. The milling tool 7 is furthermore held on the base body 4 to be vertically adjustable in a motorized manner, and can be displaced upwards and downwards specifically parallel to the pivot axis 14. The arrangement is configured accordingly for this, although this cannot be seen in the simplified figures. Both the pivotal movement and the vertical adjustment take place in a motorized manner via motors which cannot be seen in the figures and which are arranged within the base body 4 or within a tool housing 15 associated with the milling tool 7.

In the illustrated exemplary embodiment, the test probes 5 likewise held on the base body 4 are eddy current test probes. These are each seated in a through bore provided at a corresponding point (c.f. in particular FIG. 2) in the hollow base body 4.

One of the eddy current test probes 5 can be seen in an enlarged illustration in FIG. 3. Each of the eddy current test probes comprises a coil former 16, which is produced in a generative manufacturing process according to the SLS (Selective Laser Sintering) method and is made from plastics material. A coil former 16 can be seen in an enlarged schematic illustration in FIG. 4. The coil former 16 possesses a winding head 17, which defines a longitudinal axis 18 of the coil former 16 and in the outer surface of which two circumferential slots 19 are formed, which each extend about a winding core 20 along the entire circumference of the winding head 17, wherein the circumferential slots 19 on the upper side and on the lower side of the winding head 17 intersect at an angle of 90° at the position of the longitudinal axis in each case. A coil wire 21 is wound in the circumferential slots 19 in the manner of a cross winding.

Owing to the circumferential slots 19, the coil former 16 has a structure with a central winding core 20, about which the coil wire 21 is placed in the manner of a cross winding, and four holding webs 22, 23, 24, 25, which extend in the longitudinal direction and protrude over the winding core 20 both in the direction of the two axial end regions of the winding head 17 and in the radial direction. In this case, the mutually diametrically opposed holding webs 22, 23, 24, 25 in each case are formed to correspond to one another, i.e. they possess the same cross-section and the same outer form. The windings of the eddy current test probes 5 are notable for a high winding count and winding density.

The form of the holding webs 22, 23, 24, 25 is configured to be adapted to the contour of the surface of the blade-root receiving slot 1 which is to be scanned or tested. It is thus ensured that the eddy current test probes 5 can be brought sufficiently close to the contour to be tested. For connection to the lines, each test probe 5 has two electrical connection tabs 26 in each case.

Each of the plurality of eddy current test probes 5 is connected to a test probe evaluation unit in the form of a conventional eddy current device 28 via lines (not illustrated in FIGS. 1 and 2), which, outside the base body 4, are all bundled in the cable 27 which can be seen in FIGS. 1 and 2.

Non-destructive testing of the rotor 2 in the region of the root-blade receiving slots 1 can take place by means of the eddy current test probes 5 in that, in a manner known per se, scanning signals are generated and measurement signals received by the eddy current test probes 5 having the coil wires 22, this taking place as the base body 4 is pushed by a user through a blade-root receiving slot 1 to be inspected and machined, for which a handle 29 is provided on the upper side of the base body 4.

To enable local association between the measurement signals acquired by the eddy current test probes 5 and the points on the rotor surface at which the test probes 5 for recording measurement signals and of the displacement of the base body 4 were positioned in each case, additional information relating to the position of the base body 4 relative to the surface to be tested is required. To obtain this, the device according to embodiments of the invention comprised two position encoder devices 30 for determining local coordinates pertaining to the acquired measurement signals, which, in the illustrated example embodiment, are arranged in the hollow base body 4. These are illustrated accordingly by a dashed line in the figures. Each of the two position encoder devices 30 comprises a respective position detection body, realized in the present case by a roller 31, which is held on the base body 4 to be rotatable about an axis of rotation 32, wherein the arrangement is such that the two axes of rotation 32 of the rollers 31 are oriented parallel to one another. As can be seen in the figures, the rollers 31 are arranged on the base body 4 in such a way that they protrude from the base body 4 in sections so as to be able to come into contact with the surface of the rotor claw 3 when the base body 4 is pushed through this by a user. One of the rollers 31 is arranged on each side of the test probe array 6, specifically one on the left and one on the right of this.

Each of the two position encoder devices 31 is designed, in reaction to its roller 31 being rotated, to output a movement signal which contains information relating to the current speed of the movement of the roller 31 or from which such information can be derived. Specifically, the position encoder devices 31 are each designed to output, as a movement signal, TTL signals shifted with respect to one another by 90°, also referred to as a 2-phase TTL signal. To this end, the position encoder devices 30 have, in addition to the rollers 31, further mechanical and electrical components which are sufficiently known from conventional art and are not illustrated in the purely schematic figures.

The device furthermore comprises a position encoder evaluation unit 33, arranged in the hollow base body 4 and in the form of a microcontroller, which is realized by an Arduino board in the illustrated exemplary embodiment. Both position encoder devices 30 are connected to the position encoder evaluation unit 33 via lines (not illustrated in the figures) extending within the base body 4. The position encoder evaluation unit 33 is furthermore connected to the eddy current device 28 via a line (likewise not shown in the figures), which, together with the lines for the test probes, runs through the cable 27 outside the base body 4.

During a testing procedure, i.e. as the base body 4 is moved through a blade-root receiving slot 1, the position encoder devices 30 transmit their movement signals to the position encoder evaluation unit 33, and this is designed and equipped to establish, at predetermined time intervals, which position encoder device 30 has the roller 31 which is currently moved the fastest. It is only ever the movement signal of the position encoder device 30 having the currently fastest-moving roller 31 which is output to the eddy current device 28 for association with the measurement signals acquired by the eddy current probes 5.

Specifically, in the exemplary embodiment described, a counter is used to determine which roller 31 is currently moving faster. If the roller 31 of one position encoder device 30 is faster, the value is incremented in a global variable. If the roller 31 of the other is faster, the same variable is decremented. Depending on whether the upper value is greater than 2 or less than −2, the correspondingly faster position encoder device 30 is selected. To prevent the counter value from running to infinity, the counting interval in the present case is restricted to the numbers between −2 and 2. In the illustrated exemplary embodiment, to prevent step losses during the switching procedure, the counting of the counter is subject to the additional condition that the two movement signals are the same. To this end, the two 2-phase TTL signals are compared directly to one another and only when there is a phase coincidence is the position encoder device 30 with the fastest roller 31 selected, i.e. a changeover takes place upon the output of the movement signal of the position encoder device to the eddy current device 28. This is intended to prevent an undesired change in the signal direction, for example, since the switching sequence in the case of 2-phase TTL signals specifies the direction of rotation.

The aforesaid becomes particularly clear upon observation of FIG. 5. In this, a 2-phase TTL signal T1 with a first phase P1 and a second phase P2, shifted by 90° with respect thereto, of the position encoder device 30 on the left in FIGS. 1 and 2 and a 2-phase TTL signal T2 with a first phase P3 and a second phase P4, shifted by 90° with respect thereto, of the position encoder device 30 on the right in FIGS. 1 and 2 is illustrated over the path s. The roller 31 of the position encoder device 30 on the left in FIGS. 1 and 2, whereof the 2-phase TTL signal T1 is transmitted by the position encoder evaluation unit 33 to the eddy current device 28 from the start of a measurement, is currently moving somewhat more slowly than that of the right, as can be seen from the larger spacing between adjacent rising and falling edges in the signal T1.

Upon fulfilling the first condition (see the associated label in FIG. 5), the right position encoder device 30 has output two edge changes more than the left. This is followed by a wait for a phase coincidence. The phase coincidence first occurs at the position labeled “condition 2” in FIG. 5. The switch to the output of the 2-phase TTL signal T2 of the right position encoder device 30 instead of the left takes place here.

The resultant 2-phase TTL output signal T3 with a first phase P5 and a second phase P6, which corresponds to the 2-phase TTL signal T1 of the left position encoder device from the start and corresponds to the 2-phase TTL signal T2 of the right position encoder device 30 from the switching time, is likewise shown in FIG. 5. If continued monitoring reveals, at a later time, that the roller 31 of the left position encoder device 30 is rotating faster than that of the right, a switching back occurs again, and so on.

All of these evaluation steps are completed with the aid of the position encoder evaluation unit 33 in the form of an Arduino board.

Of course, a procedure which deviates from that above can also be used as long as it is equally suitable for determining which roller 31 is currently the fastest.

By using two position encoder devices 30 arranged on both sides of the test probe array 6, it is ensured, on the one hand, that local coordinates are available for the entire scanning procedure of a blade-root receiving slot 1 by means of the eddy current test probe array 6. Specifically, the roller 31 of the position encoder device 30 on the left in FIGS. 1 and 2 is already set in motion before the first eddy current data can be obtained by means of the eddy current test probe array 6. If the left roller 31 has already again left the blade-root receiving slot 1 on the side facing to the left in FIG. 1, the roller 31 of the right position encoder device 30 is still in contact with the shaft claw 3 and provides local information relating to the measurement data acquired by means of the test probe array 6. On the other hand, it is ensured that, in the event that a roller 31 moves too slowly due to a fault, for example as a result of slip caused by dirt on the rotor surface, reliable local information can still be provided via the roller 31 of the second position encoder device 30.

With regard to the milling of the shaft claw 3 in the region of the blade-root receiving slot 1, this takes place according to embodiments of the invention in a targeted manner depending on locally resolved information relating to flaws, in particular cracks, present in the rotor 2 in the region of the blade-root receiving slots 1, which information is obtained by means of the test probe array 6.

Specifically, on the basis of eddy current measurement data, which are acquired by means of the test probe array 6 and are available, locally resolved, as a result of the local information provided by the position encoder devices 30, the positions on the shaft claw 3 at which the milling tool 7 rotating about the tool axis of rotation 13 for material removal is brought into engagement with the shaft claw 3 in order to remove material in a region where flaws are present is controlled in an automated manner. In this case, the depth to which the milling tool 7 is driven into the shaft claw 3 at the respective positions is also controlled in an automated manner depending on the locally resolved eddy current measurement data provided.

To control the milling tool 7, the device has a control device 35 which, in the exemplary embodiment described, is realized by a further microcontroller in the form of a further Arduino board and which is likewise located within the hollow base body 4. The control device 35 for the tool control is connected to the motors (not shown in the figures) for the vertical adjustment, for the pivotal movement about the pivot axis 14 and for the rotation of the milling tool 7 about the tool axis of rotation 13. The control device 35 for the tool control is likewise connected to the eddy current device 28 in order to receive locally resolved eddy current data from this and to the position encoder devices 31 for positioning the milling tool 7. The control device 35 analogously to the position encoder evaluation unit 33 is designed and equipped to determine which roller 31 is currently moving the fastest and to always use the movement signal of the fastest-moving roller 31 for the positioning of the milling tool 7 relative to the base body 4.

To detect and subsequently remove flaws, for instance cracks, in the region of the blade-root receiving slot 1, the base body 4 is moved manually by a user through the blade-root receiving slot 1. In the illustrated exemplary embodiment, the base body 4 is firstly moved once through the slot 1, during which eddy current measurement data and associated local information are acquired.

The base body 4 is them moved through the slot 1 several more times in order to remove all of the flaws detected in a non-destructive manner during the measuring pass by material removal.

During the further machining passes, the rotated milling tool 7 is only driven into the shaft claw 3 in the region of the blade-root receiving slot 1 via a targeted pivotal movement about the pivot axis 14 at points where a flaw is present as per the non-destructive testing by means of the test probe array 6. The amount by which the milling tool 7 is pivoted, i.e. the machining depth at the respective point, is controlled in this case depending on the relative flaw depth revealed by the flaw measurement data. If flaws, for instance cracks, are present at different slot-depth positions, i.e. at different radial positions, the milling tool 7 is moved in an automated manner in each case into different radial positions for the multiple passes and, in the respective radial position, the milling tool 7 is only driven into the rotor 2 in an automated manner via a pivotal movement about the pivot axis 14 at those axial positions in which, according to the eddy current measurement data, flaws are present.

To discharge material chips produced as a result of the milling process, a suction device (not illustrated in the figures) is connected to the suction nozzles 36.

Alternatively, to the illustrated exemplary embodiment, a computer, for example a laptop, can also be used as the control device, which can then be connected to the motors via further lines, in particular likewise leading out of the base body 4 in a bundle through a cable.

FIGS. 6 and 7 show a second embodiment of a device according to embodiments of the invention for milling a rotor in the region of blade-root receiving slots 1. Identical components are denoted by identical reference signs.

The essential difference between the first and the second embodiment of the device according to embodiments of the invention consists in that the means for the non-destructive testing of the blade-root receiving slot 1, i.e. the eddy current test probe array 6, and the means for removing flaws, i.e. the milling tool 7, are spatially separated from one another, specifically they are held on two separate base bodies 4.

Accordingly, the second embodiment of the device according to embodiments of the invention comprises two hollow base bodies 4, which are notable for identical outer contours and, in the present case, are identical to the base body 4 of the device according to the first embodiment. In this case, the eddy current test probe array 6 is held on the one base body 4 (c.f. FIG. 6) and the milling tool 7 is held on the other base body 4 (c.f. FIG. 7). Both the first and the second base body 4 analogously to the first embodiment are each provided with two position encoder devices 30, each with a roller 31, so that the advantages already discussed above are realized both for the acquisition of measurement data and for the milling process.

In this case, those position encoder devices 30 which are arranged on the base body 4 supporting the milling tool 7 serve in particular for reliable positioning of the milling tool relative to the rotor to be machined when the base body 4 supporting the milling tool 7 is moved manually by a user through the blade-root receiving slot 1.

As in the first exemplary embodiment, both the position encoder evaluation unit 33 and the control deice 35 for the tool control are each realized by an Arduino board, wherein the Arduino board serving as a position encoder evaluation unit 33 is arranged in the hollow base body 4 supporting the test probe array 6 and the Arduino board serving as a control device 35 for the tool control is arranged in the hollow base body 4 supporting the milling tool 7 and the corresponding connections are realized by lines. The position encoder evaluation unit 33 and the control device 35 are designed and equipped analogously to the first exemplary embodiment described above.

The base body 4 supporting the test probes 5 analogously to the first embodiment is connected to an eddy current device 28 (not illustrated in the figure) via the cable 27.

If the second exemplary embodiment of the device according to embodiments of the invention is used, the first and the second base body 4 are pulled in succession through a blade-root receiving slot 1 to be tested and machined; specifically, firstly that base body 4 which supports the test probe array 6 for the acquisition of locally resolved eddy current measurement data and then that base body 4 which is provided with the milling tool 7 in order to remove material in the region in which flaws are present on the basis of the data provided, wherein, according to embodiments of the invention, automated control of the milling tool 7 takes place depending on the eddy current measurement data.

In the illustrated exemplary embodiment, the eddy current measurement data acquired by means of the test probes 5 and the positional data acquired by means of the position encoder devices 30 are prepared and processed on a computer (not illustrated in the figures). For example, an envelope or a plurality of envelopes pertaining to different slot depths are calculated, which include(s) all of the detected flaws. The computer transmits the prepared data to the control device 35 for controlling the milling tool 7 and this is controlled depending on the data, whilst the base body 4 supporting the milling tool 7 is pushed manually through the blade-root receiving slot 1. The control is realized, for example, in such a way that material removal corresponding to the envelope or envelopes is achieved. This procedure enables the removal of material to be optimally adapted to actual flaw-related findings and a contour which is, itself, again easily testable to be obtained. The envelope calculation and corresponding subsequent material removal can, of course, also take place within the framework of the first exemplary embodiment, described above, having one base body.

The use of the device according to embodiments of the invention for carrying out the method according to embodiments of the invention is associated with diverse advantages. On the one hand, the quantity of material removed is reduced considerably compared to conventional art, in particular to the possible minimum based on the actual flaw-related findings. Moreover, calculable machining contours are obtained in particular as a result of the motorized control of the milling tool 7. These are particularly suitable as a basis for calculating the service life. Were detected flaws to be removed using a fully hand-operated tool, there would be a lack of certainty in terms of the geometry of the resultant contours.

The machining contours resulting from the post-machining according to embodiments of the invention are notable since material is only ever removed at those axial positions at which flaws are actually present due to a non-constant cross-section in the axial direction. To enable reliable non-destructive re-testing of machining contours produced in the manner according to embodiments of the invention, it can furthermore be provided that the test probes 5 of the test probe array 6 on the base body 4 analogously to the resilient pressure pieces 11—are held in a resilient manner on the base body 4 in such a way that they protrude outwards from the base body 4 and are movable into the base body 4 in the direction thereof in opposition to a spring force.

An exemplary embodiment of the resilient mounting of the test probes 5 on a hollow base body 4 is revealed in FIG. 8. The figure shows a sectional view of the inside of the wall 37 of an open hollow base body 4, as can be seen in FIGS. 1 and 2 and 5 and 6. The resilient mounting is realized via metal spring elements 38, which, at their one end, are fixed to the inside of the wall 37 of the base body 4 by means of screw 39 and, at their other end, reach over the rear side of a respective test probe 5, into which a line 34 leads. If a force is exerted on a test probe 5 from the outside, this test probe is displaced inwards within the through-bore receiving it in opposition to the then-yielding spring element 38. If there is no force acting from the outside, the test probe 5 protrudes by a defined axial amount from the base body 4. In this state, stops 40 projecting from the test probe 5 abut against the inside of the wall of the base body 4. The screws 39 fixing the respective spring element 38 in place are each screwed into a threaded bore, which is provided in a cylindrical projection 41 projecting inwards from the wall 37 and the test probes 5 are each seated in a through-bore, which is likewise provided in such a cylindrical projection 41.

If a base body 4 fitted with test probes 5 held in such a resilient manner is moved through a blade-root receiving slot 1, the test probes 5 even follow already-produced machining contours which are notable for having a varying cross-section. As a result of this configuration, the eddy current probes 5 can be used at different milling depths. The resiliently mounted test probes are preferably configured in such a way that their contour is adapted to the contour of the milling tool 7 used in the previous machining procedure. The test probes 5 can then nestle in the milled slot according to the milling depth and are minimally spaced, in the optimum case not spaced, from the surface to be measured. Since, with resilient mounting, the test probes 5 are always in contact with the component surface even in the case of slots with an axially varying milling depth, they also provide reliable measurement data relating to the presence of flaws for components which are post-machined according to embodiments of the invention.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for carrying out material-removing machining of a component, within a slot provided within the component, the method comprising:
providing locally resolved measurement data, which comprise information relating to flaws in the component, and
material-removing machining by at least one machining tool, of the component, wherein the at least one machining tool is mounted to be displaceable and/or pivotable in a motorized manner, and the positions on the component at which the at least one machining tool is brought into engagement with the component in order to remove material in a region where flaws are present are controlled in an automated manner depending on the measurement data provided, and the depth to which the at least one machining tool is driven into the component is controlled in an automated manner depending on the measurement data provided.

2. The method as claimed in claim 1, wherein a base body, on which the at least one machining tool is held to be movable in a motorized manner, is displaced manually along the component and the positions on the component at which the at least one machining tool is moved relative to the base body in such a way that it comes into engagement with the component in order to remove material are controlled in an automated manner depending on the measurement data provided.

3. The method as claimed in claim 2, wherein the at least one machining tool is held on the base body to be pivotable about a pivot axis and/or displaceable along a linear displacement path, and the positions on the component at which the at least one machining tool is pivoted about the pivot axis and/or displaced along the displacement path and the amount by which the at least one machining tool is pivoted about the pivot axis and/or displaced along the displacement path are controlled depending on the measurement data provided.

4. The method as claimed in claim 2, wherein material-removing machining takes place within a blade-root receiving slot of a turbo-machine, and measurement data are provided, which, at least with regard to the direction of the longitudinal extent of the slot, comprise locally resolved information relating to flaws in the component in the region of the slot, and the base body is displaced in the direction of the longitudinal extent of the slot.

5. The method as claimed in claim 2, wherein
a base body, on which at least one test probe for non-destructive testing of the component is held, is displaced along the component and, using the at least one test probe held on the base body, measurement data are acquired, which comprise locally resolved information relating to flaws in the component, and the acquired measurement data are provided for controlling the at least one machining tool held on the base body.

6. The method as claimed in claim 2, wherein
two base bodies, having substantially the same form, are displaced in succession along the component, wherein at least one test probe for non-destructive testing of the component is held on the first base body displaced first along the component, and, using the at least one test probe held on the first base body, measurement data are acquired, which comprise locally resolved information relating to flaws in the component, and wherein the at least one machining tool is held to be movable in a motorized manner on the second base body displaced subsequently along the component, and the measurement data acquired using the at least one test probe held on the first base body are provided for controlling the at least one machining tool-(7) held on the second base body.

7. The method as claimed in claim 1, wherein the measurement data provided in relation to the depth of flaws present in the component comprise corresponding depth values, in particular amplitude values and local coordinates which are associated with the depth values in each case and indicate the respective flaw position, and in that the at least one machining tool is brought into engagement with the component at positions at which, according to the measurement data, the depth value is higher than a predetermined limit value and/or the at least one machining tool is driven into the component in each case by a depth which is dependent on the amount of the depth value.

8. The method as claimed in claim 1, wherein, on the basis of the measurement data provided, at least one envelope is calculated, which includes a plurality of the flaws present according to the measurement data, and in that the at least one machining tool is controlled in such a way that material removal corresponding to the at least one envelope is achieved.

9. A device for material-removing machining of component, within a slot provided in the component, comprising:
an elongated base body, which is to be displaced along a component for machining thereof,
at least one material-removing machining tool, which is held on the base body to be movable in a motorized manner, in particular displaceable and/or pivotable in a motorized manner,
at least one position encoder device, held on the base body for determining local coordinates, and
a control device, which is connected to the at least one machining tool and in particular the at least one position encoder device, via cables, and is designed and equipped to receive locally resolved measurement data, which comprise information relating to flaws in a component be machined, and to control the at least one machining tool depending on the measurement data.

10. The device as claimed in claim 9, wherein at least one test probe for non-destructive testing of a component is provided, which is arranged on the base body or on a further base body, having at least substantially the same form as the base body, on which at least one further position encoder device for determining local coordinates is held, and the control device is connected to the at least one test probe and equipped to control the at least one machining tool depending on measurement data acquired by the at least one test probe.

11. The device as claimed in claim 9, wherein at least two position encoder devices for determining local coordinates are held on the base body, and the position encoder devices each have a position detection body, which is movably, in particularly rotatably, held on the base body and is arranged in such a way that it can be brought into contact with the surface of a component to be inspected, wherein each position encoder device held on the base body, is designed, in reaction to its position detection body being moved relative to the base body, to output a movement signal which contains information relating to the current speed of the movement of the position detection body relative to the base body or from which such information can be derived, and a position encoder evaluation unit, arranged in particular in the base body, is provided, which is connected to the position encoder devices held on the base body and is designed and equipped to receive movement signals from the position encoder devices during operation and to establish, continuously or at predetermined time intervals, which position encoder device held on the base body has the fastest-moving position detection body, and in particular to output the movement signal of the position encoder device having the fastest-moving position detection body.

12. The device as claimed in claim 10, wherein the at least one test probe is arranged on a further base body, and at least two position encoder devices for determining local coordinates are held on the further base body, and the position encoder devices each have a position detection body which is movably, in particular rotatably, held on the further base body and is arranged in such a way that it can be brought into contact with the surface of a component to be inspected, wherein each position encoder device held on the further base body is designed, in reaction to its position detection body being moved relative to the further base body, to output a movement signal which contains information relating to the current speed of the movement of the position detection body relative to the further base body or from which such information can be derived, and a position encoder evaluation unit, arranged in particular in the further base body, is provided which is connected to the position encoder devices held on the base body and is designed and equipped to receive movement signals from the position encoder devices during operation and to determine, continuously or at predetermined time intervals, which position encoder device held on the further base body has the fastest-moving position detection body, and in particular to output the movement signal of the position encoder device having the fastest-moving position detection body.

13. The method as claimed in claim 9, wherein the base body and in particular the further base body has a substantially constant cross-section along its longitudinal extent and/or in that the base body and in particular the further base body has a fir-tree- or swallow- or tee-shaped or hammer-head-shaped cross-section.

14. The method as claimed in claim 9, wherein the at least one machining tool is held on the base body to be pivotable about a pivot axis and/or displaceable along a linear displacement path and, in particular, the control device is designed and equipped to pivot the at least one machining tool about the pivot axis and/or displace it along the displacement path depending on the measurement data provided.

15. The method as claimed in claim 9, wherein the control device is designed and equipped to carry out the method.
